(19) United States
(12) Patent Application Publication
(10) Pub. No.: US 2012/0245850 A1
(43) Pub. Date: Sep. 27, 2012

(54) AZIMUTH INITIALIZATION AND CALIBRATION OF WELLBORE SURVEYING GYROSCOPIC AND INERTIAL INSTRUMENTS BY MEANS OF AN EXTERNAL NAVIGATION SYSTEM

(76) Inventors: Jon Bang, Trondheim (NO); Torgeir Torkildsen, Trondheim (NO)

(21) Appl. No.: 13/504,598

(22) PCT Filed: Nov. 1, 2010
(86) PCT No.: PCT/NO10/00394

§ 371 Date: Jun. 13, 2012

Related U.S. Application Data
(60) Provisional application No. 61/256,398, filed on Oct. 30, 2009.

(51) Int. Cl. G06F 19/00; G01V 8/16; G01V 8/12; G01V 9/00

(52) U.S. Cl. 702/9; 702/11

(57) ABSTRACT

It is described a system and a method for for azimuth initialization of a gyroscopic and/or inertial instrument for wellbore surveying, said system comprising:—a rigid reference structure to which the gyroscopic and /or inertial instrument is rigidly connectable;—an external navigation system for providing an azimuth measurement as a function of time, and wherein the rigid reference structure provides a rigid orientation between the external navigation system and the gyroscopic and/or inertial instrument; —a processor operable to synchronize the azimuth measurement as a function of time with an orientation as a function of time of the gyroscopic and/or inertial instrument.

### INTRODUCTION

The present invention concerns a system and a method for azimuth initialization and calibration of a gyroscopic and/or inertial instrument for wellbore surveying.

### BACKGROUND

Wellbore surveying is done for several reasons. Optimal well placement comprises to the ability to hit the geological target, avoid faults or hazard zones, and other directional concerns like target entry angle, dogleg restrictions, etc. Safety aspects include avoiding collision with other wells, and appropriate placement of relief wells. Furthermore, surveying aids reservoir exploitation through improvement of reservoir models and reservoir engineering.

FIG. 1 shows the principle for wellbore surveying. The purpose of the survey is to obtain position co-ordinates NEV along the wellbore w, where N is north, E is east, and V is vertical co-ordinates. The NEV co-ordinate system is orthogonal. There exists no method that is capable of measuring the NEV co-ordinates directly, in the underground situation. Instead, the common procedure is to derive these co-ordinates from measurements of the following three parameters: Depth along the borehole (D), which is measured from a reference point on the drilling rig; Inclination angle (I), which is the deviation from the vertical direction; Azimuth angle (A), which is the angle with the north direction of the projection of the wellbore onto the horizontal (N-E) plane. NEV co-ordinates at specific wellbore locations are calculated as the wellbore start position plus co-ordinate increments derived from the measured D, I, A. The measurements can be done during drilling (MWD) or as a wireline operation after drilling. D is measured as the length of drill string or wireline inserted into the borehole. I is measured by a set of accelerometers, which registers the orientation of the instrument body with respect to the earth's gravity direction. The same principle is using during drilling and during wireline operation. The azimuth angle A can be measured by two different sensor principles: either by a magnetometer, utilizing the earth's magnetic field and magnetic north direction as the reference; or by gyroscopic sensors, which registers the rotation of the instrument body, including the rotation of the earth itself. The gyro's reference direction is thus the geographical north pole. Magnetic instruments are usually preferred for MWD purposes, due to robustness, whereas gyroscopic instruments are preferred for wireline surveys. Inclination and depth are generally measured by the same principles for both instrument classes.

GB 2 445 201 concerns a wellbore surveying system using a Global Positioning System (GPS). The GPS system is queried when obtaining initial surface position and orientation data. US20040148093A1, US20070136019A1 and US 007219013B1 deal with integration of GPS and an inertial/gyroscopic system. The GPS is a single antenna system which provides discrete positions and the inertial system measures movements. All measurements are fed into a navigation filter which produces the position and dynamics of the object of interest. The inertial platform does not align itself versus the north direction, and the alignment is introduced as a parameter in the filter which indirectly is determined by the GPS and inertial data. However, a precise estimation of the alignment angle is dependent of substantial movements of the object.

This contradicts to an embodiment of this invention where the alignment of an inertial platform is determined by the multi-antenna GPS system, solely.

The principles of prior art use of a GPS in azimuth alignment are discussed in A. O. Salycheva, M. E. Cannon, 2004: “Kinematic Azimuth Alignment of INS using GPS Velocity Information”. NTM 2004 Conference, San Diego, Calif., January 2004.

Wellbore surveying is either done while the well is being drilled (MWD; Measurement While Drilling), or after drilling is completed. MWD surveying traditionally uses magnetic instruments; however, MWD gyroscopic surveying is an upcoming technology. MWD measurements are stationary. Surveying after drilling mainly uses gyroscopic instruments, either in stationary or in continuous mode. A typical survey program will include various magnetic and gyroscopic surveys, depending on accuracy and reliability requirements, and operational and environmental constraints. Gyroscopic azimuth measurements can be done either in stationary or continuous mode.

Stationary Mode

In stationary mode, azimuth is determined by gyrocompassing; i.e. the azimuth angle is calculated from the projections of the earth rotation along the sensitive axes of the gyro. In order to reduce the effect of gyro random noise, the sensor readings are obtained by averaging during a period of typically 1-20 minutes. In several tools, used for wellbore surveying, the gyro biases (systematic noise) are cancelled out by performing the measurements in two opposite directions by rotating the sensors inside the gyro tool housing. Both the averaging and the bias cancelling process require that the tool is kept stable during these type of measurements. Thus the operation is called stationary mode. The azimuth angles are measured directly at discrete positions along the wellbore and it is very time consuming.

FIG. 3 shows the flow-chart of a stationary gyroscopic survey. The term is stationary implies that the instrument is halted at regular intervals along the wellbore, and azimuth measurements are performed, so-called gyrocompassing, at these survey stations. During these measurements, the instrument must be completely stable.

The surveying procedure comprises:

On-site calibration 101 on platform deck before survey. Inrun 102 which is the surveying of the wellbore. Outrun 103 during which an optional redundant survey can be performed while the instrument is pulled out of the borehole. Calibration 104 is an optional recalibration to ensure instrument integrity which is performed on the platform deck after survey.

The standard calibration procedure requires that the instrument is completely stable, and it can therefore not be performed on a floating rig. This leads to degraded azimuth accuracy compared to the situation on a fixed rig.

Continuous Mode

In continuous mode, azimuth is initialized through one stationary measurement at the beginning of the wellbore section to be surveyed. After the initialization the gyro is switched to continuous mode; i.e. the azimuth changes are measured by integrating the gyro movements, continuously. Thus the azimuth can be determined when the tool is moving, and the surveying along the wellbore can be performed very fast compared to the discrete and time consuming stationary surveying; however, it is preferable to perform zero-velocity updates to eliminate sensor drift.

FIG. 4 shows the flow-chart of a continuous gyroscopic survey.

The surveying procedure is as follows. On-site calibration 111 is performed on the platform deck before survey. Initialization 112 is one gyrocompassing measurement. The initialization provides the azimuth reference for the inrun 113. Inrun 113 is the continuous surveying of the wellbore. Outrun 114, initialization 115 and calibration 116 are optional and similar to 111, 112, and 113 in reversed order. This redundant surveying improves the accuracy and the reliability of the final survey results.

Some Factors Limiting the Azimuth Accuracy of Gyroscopic Surveys

Initialization

The accuracy of a continuous survey degrades with increasing latitude (both north and south). This is due to that azimuth is initialized by gyrocompassing; i.e. the azimuth angle is calculated from the projections of the earth rotation along the sensitive axes of the gyro. The horizontal component of earth rotational rate decreases to zero at the poles, and the azimuth determination deteriorates accordingly. The standard initialization procedure yields an azimuth uncertainty versus geographical latitude according to FIG. 2. FIG. 2 shows how the azimuth uncertainty of a gyroscopic survey changes with latitude, when the instrument is initialized through standard procedures. The azimuth uncertainty is normalized to 1 for a wellbore located on the equator. Mathematically, the uncertainty dAz follows the relation dA˜1/cos(φ), where φ is the geographical latitude. For southern latitudes, the uncertainty increases in the same way towards the south pole. Accuracy degradation towards the poles is described in: J. Bang, T. Torkildsen, B. T. Bruun, S. T. Håvardstein, 2009: “Targeting Challenges in Northern Areas due to Degradation of Wellbore Positioning Accuracy”. SPE 119661, SPE/IADC Drilling Conference and Exhibition, Amsterdam, The Netherlands, March 2009.

Fundamental principles for gyroscopic tools for wellbore surveying and error sources and their effect on azimuth determination are provided in: Torgeir Torkildsen, Stein T. Håvardstein, John L. Weston, Roger Ekseth, 2008: “Prediction of Wellbore Position Accuracy When Surveyed With Gyroscopic Tools”. SPE Journal of Drilling and Completion 1/2008.

Furthermore, today's initialization procedure requires the gyroscopic instrument to be stable during initialization, and this is difficult to achieve when surveying from floating installations. This may be achieved by clamping the instrument to the borehole, so that it is unaffected by rig motion. The standard initialization procedure typically lasts 30 minutes.

On-Site Calibration

The instability of most gyroscopic sensors requires that the calibration is checked immediately before surveying. Gyro biases, scale factor errors, mass unbalances, quadrature errors etc. are examples of characteristic parameters that are checked during the on-site calibration. According to today's practice, calibration can not be performed on a floating installation/rig, because the tool has to be kept stable during a series of several measurements. The lack of on-site calibration implies reduced accuracy and reliability for both stationary and continuous surveys.

It should be noted that also the accuracy of magnetic azimuth measurements shows degradation with latitude very similar to the trend in FIG. 2, although caused by different physical effects.

### SUMMARY OF THE INVENTION

In a first aspect the invention provides a system for azimuth initialization of a gyroscopic and/or inertial instrument for wellbore surveying, said system comprising: a rigid reference structure to which the gyroscopic and/or inertial instrument is rigidly connectable; an external navigation system for providing an azimuth measurement as a function of time, and wherein the rigid reference structure provides a rigid orientation between the external navigation system and the gyroscopic and /or inertial instrument; and a processor operable to synchronize the azimuth measurement as a function of time with an orientation as a function of time of the gyroscopic and/or inertial instrument.

The external navigation system may be a standalone inertial navigation system. The external navigation system may be a radio navigation system. The external navigation system may be a satellite navigation system, e.g. GPS, GLONASS or Galileo.

In an embodiment, at least two antennas for receiving signals from the radio navigation system may be provided, wherein the antennas are attached to the rigid reference structure. A receiver may be arranged to be operable to perform synchronous measurements of a carrier phase of at least one signal received by said at least two antennas providing the azimuth as a function of time of the at least two antennas. The system may further comprise a further inertial system for providing a dip angle, enabling a fixation of an orientation of a 3D coordinate system in time for the at least two antennas.

In a further embodiment at least three antennas may be provided enabling a fixation of an orientation of a 3D coordinate system in time for the at least three antennas.

The system may comprise an instrument platform connected to said rigid reference structure to which said gyroscopic or inertial instrument may be rigidly mounted. The instrument platform may be arranged to provide a horizontal plane. The instrument platform may be arranged to provide a vertical plane.

The gyroscopic and/or inertial instrument may comprise a gyroscopic sensor and/or an inertial sensor selected from the group including rotating mass gyro, fibre optical gyro, ring laser gyro, vibrating structure gyro/Coriolis vibratory gyro; strap-down and gimballed configurations.

The wellbore surveying may be a stationary or continuous gyro survey. The gyroscopic and/or inertial instrument may be applicable for both MWD surveys and surveys after drilling. The gyroscopic and/or inertial instrument may be for use in any mode of motion including fixed, translation, rotation, vibration, and resonance oscillations. The system may be applicable to gyroscopic and/or inertial instruments used onshore and/or offshore. The system may be applicable on both floating and fixed installations.

In a second aspect the invention provides a gyroscopic and/or inertial instrument for wellbore surveying comprising a system for azimuth initialization according to above.

In a third aspect the invention provides a method for azimuth initialization of a gyroscopic and/or inertial instrument for wellbore surveying, comprising:

registering orientation and change of orientation as a function of time during azimuth initialization of said gyroscopic and/or inertial instrument by the external navigation system providing an azimuth measurement as a function of time,

registering, during azimuth initialization, orientation and movement as a function of time of said gyroscopic and/or inertial instrument by the inertial registration system of said gyroscopic and/or inertial instrument, and

synchronizing the azimuth measurement as a function of time provided by the external navigation system with the orientation and movement provided by the inertial registration system of the gyroscopic and/or inertial instrument

The method may further comprise receiving signals from at least two antennas of the radio navigation system, and performing synchronous measurements of a carrier phase of at least one signal received by said at least two antennas providing the azimuth as a function of time of the at least two antennas. Further, a further inertial system for providing a dip angle, enabling a fixation of an orientation of a 3D coordinate system in time for the at least two antennas may be provided. The gyroscopic and/or inertial instrument may utilize any type of gyroscopic sensors and/or inertial sensors including: rotating mass gyros, fibre optical gyros, ring laser gyros, vibrating structure gyros/Coriolis vibratory gyros; strap-down or gimballed configurations. The external navigation system is a space satellite system, including but not limited to: GPS, GLONASS and Galileo. The method may be applicable to both stationary and continuous surveys. The method may be applicable to any gyroscopic and/or inertial instrument for both MWD surveys and surveys after drilling, and with any telemetry or memory options. The method may be applicable at any geographical location, including far north and far south latitudes. The method is applicable to gyroscopic and/or inertial instruments in any mode of motion: fixed, translation, rotation, vibration, and resonance oscillations. The method is also applicable to gyroscopic and/or inertial instruments used onshore and/or offshore. The method is further also applicable on both floating and fixed installations.

In a fourth aspect the invention provides use of a system for azimuth initialization according to above for calibration of a gyroscopic and/or inertial instrument for wellbore surveying.

The invention comprises use of an external navigation system for calibration and azimuth initialization of gyroscopic and inertial surveying instruments.

The invention is applicable to, and will imply improvements to, both stationary and continuous gyroscopic surveys, on both fixed and floating installations.

The invention provides a new way of initializing the continuous gyroscopic service that will overcome the drawbacks of the standard procedures. The initialization is done by means of an external navigation system, e. g., a satellite positioning system like GPS, GLONASS, or Galileo. The use of an external navigation system implies that the azimuth accuracy will be independent of geographical latitude.

An add-on feature will be the possibility to perform on-site calibration even on a floating platform. This issue is relevant for both continuous and stationary gyroscopic services. The new calibration procedure, offered by this invention, can be performed on a floating rig, thus yielding the same azimuth accuracy as is achieved on a fixed rig. The new initialization procedure, which is offered by this invention, yields an azimuth uncertainty that is independent of geographical latitude and equal to the uncertainty on the equator. The new procedure can be performed when the instrument is moving, so clamping to non-moving rig parts is not necessary. Thus, initialization may be carried out with the instrument on the platform deck. The duration of the new initialization procedure is estimated to 5 minutes.

The on-site calibration procedure is the same as for stationary surveys. Thus, for continuous surveys, the invention will imply the same improvements to the calibration procedure as for stationary surveys, i. e., calibration can be carried out on floating rigs, and with the same resulting accuracy as on a fixed rig.

The invention provides azimuth alignment of a gyroscopic tool by transferring azimuth angle from an external navigation system. This also applies for kinematic situations; moving platform etc.

Initialization of azimuth for a continuous gyroscopic survey by existing technology: Gyro-compassing provides: The tool must be stable through all the gyro-compassing procedure. The procedure is time consuming, 20-30 minutes. The accuracy decreases towards the poles.

Initialization of azimuth for a continuous gyroscopic survey according to the new technology according to the invention provides: Gyro alignment by means of an external navigation system. The initialization and calibration may be performed also in a kinematic situation. The procedure is quick, 5 minutes. The accuracy is independent of geographic latitude.

Calibration of gyroscopic sensors includes; biases, scale factors, mass unbalances, quadrature effects etc.

In existing technology the tool must be stable for all the measurements, including stable bracket arrangement. The invention provides a method which can be performed also in a kinematic situation.

### BRIEF DESCRIPTION OF DRAWINGS

Example embodiments of the invention will now be described with reference to the followings drawings, where:

FIG. 1 illustrates the principle for wellbore surveying, showing the measurements of azimuth A (angle in horizontal plane from north direction), inclination I (angle from vertical direction), and depth D (distance along wellbore) used for derivation of position co-ordinates N (north), E (east), and V (vertical) of points along a wellpath for a wellbore survey;

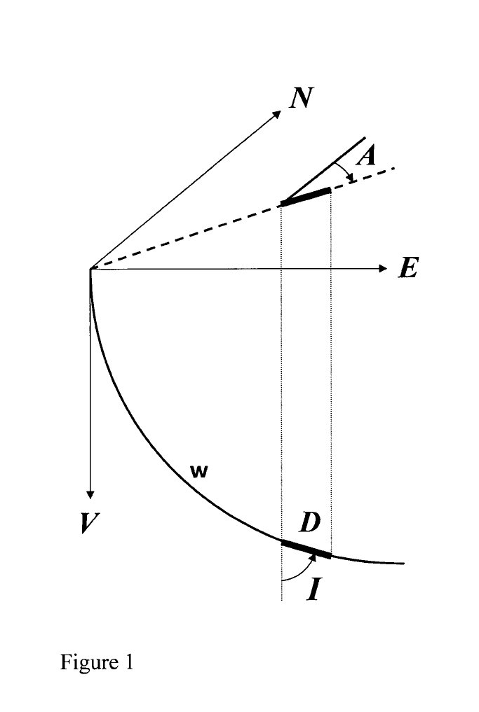

FIG. 2 shows azimuth uncertainty of gyroscopic surveys as a function of geographic latitude, normalized to 1 on the equator according to prior art;

FIG. 3 is a flowchart illustrating a procedure of a stationary wellbore survey;

FIG. 4 is a flowchart illustrating a procedure of a continuous wellbore survey;

FIG. 5 illustrates a gyroscopic/inertial instrument 123 mounted on an instrument platform 122, an external navigation system 120 and a rigid reference structure 124 connecting the external navigation system and the instrument platform, according to an embodiment of the invention;

FIG. 6 shows a gyroscopic/inertial instrument 123 mounted on an instrument platform 122 and three satellite antennas C₁, C₂ and C₃ mounted on an antennae platform 121 which is rigidly attached to reference structure 124, according to an embodiment of the invention;

FIG. 7 shows a principle for determining the azimuth angle of the satellite antenna baseline according to an embodiment of the invention; and

FIG. 8 shows the azimuth orientation of the external navigation system 201 from FIG. 5, and of the azimuth orientation of the gyroscopic/inertial instrument 202, as seen from above (projected onto the horizontal plane) according to an embodiment of the invention;

FIG. 9 shows the azimuth orientation of the satellite antenna and of the gyroscopic/inertial instrument 123, as seen from above (projected onto the horizontal plane) according to an embodiment of the invention;

FIG. 10 shows the flowchart for processing of the readings from the external navigation system and from the gyro instrument according to an embodiment of the invention; and

FIG. 11 shows the attainable improvement in azimuth accuracy of a continuous survey as a function of geographical latitude according to the invention.

### DETAILED DESCRIPTION

The present invention will be described with reference to the drawings. The same reference numerals are used for the same or similar features in all the drawings and throughout the description.

The technical solution comprises:
A gyroscopic/inertial instrument rigidly connected to an external navigation system, whose orientation and change in orientation as a function of time during calibration and initialization of the gyroscopic instrument is registered by the satellite receiver.
During calibration and initialization, the gyro-instrument's orientation and movements are registered by the gyro-instrument's normal registration system.
The two registrations above are synchronized in order to improve the calibration and initialization accuracy of the gyro/inertial-instrument.

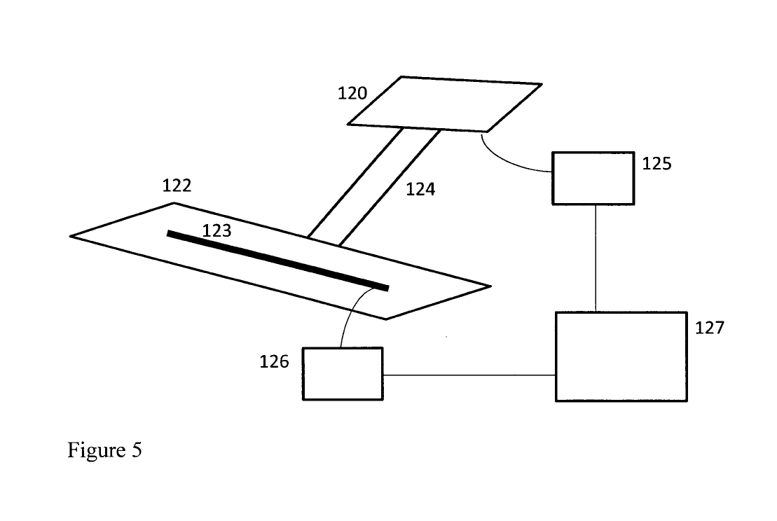

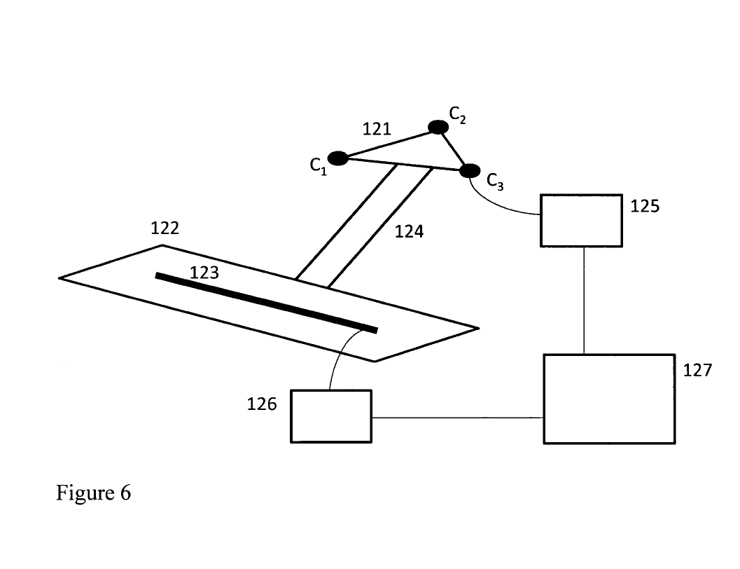

Embodiments of the invention are shown in FIGS. 5 and 6.

FIG. 5 shows the physical components involved in a system for azimuth initialization and calibration according to an embodiment of the invention. A gyroscopic/inertial instrument 123 is mounted on an instrument platform 122. In FIG. 5 the instrument platform 123 is arranged in a horizontal position. However, in an alternative embodiment the instrument platform 122 and the instrument 123 may be arranged in a vertical position. An external navigation system 120 is connected to a rigid reference structure 124. The instrument platform is also rigidly connected to the rigid structure 124. The rigid structure 124 thus interconnects the external navigation system and the instrument platform providing a mechanically rigid connection between the gyro or inertial instrument 123 on the platform and the external navigation system. Both the external navigation system and the gyro/inertial instrument will thus move together. The structure 120-124-122 has sufficient rigidity such that the possible movements of the external navigation system equal the movement of the instrument 123, within a specified tolerance. The external navigation system may be an inertial navigation system with high accuracy, e.g. as used in the space industry.

A receiver 125 of the external navigation system registers the change of orientation as a function of time during azimuth initialization of said gyroscopic and/or inertial instrument and provides an azimuth measurement as a function of time. This azimuth measurement is provided to a processor/computer 127. A control and logging unit 126 for the gyro /inertial instrument 123 receives signals from the gyro/inertial instrument during azimuth initialization of orientation and movement as a function of time of said gyroscopic and/or inertial instrument by the inertial registration system of said gyroscopic and/or inertial instrument. The processor/computer 127 synchronizes the azimuth measurement as a function of time provided by the external navigation system with the orientation and movement provided by the inertial registration system of the gyroscopic and/or inertial instrument.

On an oil rig, the gyro or inertial instrument may be arranged on the platform deck and the external navigation system on e.g. the helicopter deck, and the oil rig itself will thus form the rigid structure interconnecting the gyro/inertial instrument to be initialized with the external navigation system. The rigid structure may also be smaller, and embodiments may include a rigid structure to be placed on the platform deck, to which the external navigation system is fixedly attached.

In an alternative embodiment, the external navigation system may be a radio/satellite navigation system including antennas. At least two antennas may be arranged for receiving signals from the radio navigation system, wherein the antennas are rigidly connected to the fixed reference structure. A receiver performs synchronous measurements of a carrier phase of at least one signal received by said at least two antennas providing the azimuth as a function of time of the at least two antennas. When using two antennas a further inertial system for providing a dip angle, enabling a fixation of a 3D coordinate system in time for the at least two antennas may be provided.

A further embodiment is illustrated in FIG. 6. The three satellite antennas C₁, C₂ and C₃ are mounted on an antenna platform 121. The antenna platform is rigidly connected to a rigid structure 124. The rigid structured may in an embodiment be a solid bracket. The use of at least three antennas enables a fixation of an orientation of a 3D coordinate system in time for the at least three antennas. A multi-channel receiver 125 performs simultaneous measurements of a carrier phase of several satellite signals at all antennas. This configuration allows for continuous registration of the 3-D orientation of the antenna system. The gyroscopic/inertial instrument 123 is mounted on an instrument platform 122. The rigid structure 124 connects 121 and 122 mechanically. The actual design of the structure comprising 121, 122, and 124 will depend on rig floor conditions like closeness to the wellhead and where free sight to satellites can be obtained. The structure 121-122-124 may thus be shaped individually for each drilling site. However, for some practical reasons a standardized shape may be preferred in certain circumstances. The structure 121-122-124 has sufficient rigidity such that the possible movements of the antennas C equal the movement of the instrument 123, within a specified tolerance. As explained above, e.g. an oil rig may form the actual rigid structure itself. 126 is the control and logging unit for the gyro instrument. This unit, and the satellite receiver 125, are both connected to a dedicated computer 127, which processes and synchronizes the registered motion of both antenna system and gyro instrument. This implies that the registered orientation of the satellite antenna is fed to the gyro system during azimuth initialization and calibration.

For the embodiments above, it is also possible to provide a different mounting (e.g. vertical) of the instrument platform 122 and the gyro 123 during azimuth initialization and calibration.

The gyroscopic and/or inertial instrument may further include a gyroscopic sensor and/or an inertial sensor. The gyroscopic sensor and/or an inertial sensor may be a rotating mass gyro, fibre optical gyro, ring laser gyro, vibrating structure gyro/Coriolis vibratory gyro; strap-down or gimballed configurations.

The following factors should be considered in the design of the framework:
Mechanical vibrations corresponding to gyro tool resonances should be avoided.
Overall stability.
Requirements to relative orientation (azimuth) of gyro tool and antenna
Mechanical shocks and rough handling of the gyro tool should be avoided after initialization

The external navigation system may be a standalone inertial navigation system. The external navigation system may however also be a radio navigation system or a satellite navigation system. Examples of satellite positioning systems that may be used for initialization and calibration are GPS, GLONASS, or Galileo.

When using a satellite system as an external navigation system, a factor in the design of the framework may be visibility of sufficient number of satellites from the antenna.

The external navigation system should typically be able to provide: determination of azimuth angle for alignment of the gyroscopic/inertial system; a measurement, update frequency≈10 Hz; accuracy≈0.1°; time-tagging≈0.05 s and “Real-time” transfer of data.

If using a GPS receiver with many channels, the phase of the carrier wave of incoming satellite signals from many satellite signals to several antennas (typically three) are measured simultaneously. This enables initialization of azimuth angle (orientation) of the gyro/inertial instrument.

Typical gyro reading rates are 100 Hz. Typical satellite reading rates are 1-100 Hz, depending on the receiver's complexity. The upper range of these data rates is considered sufficient to track expected rig movements.

The accuracy of the satellite antenna's orientation, and thus of the gyro instrument's orientation, depends on the physical size of the antenna, represented by the antenna's baseline.

The azimuth accuracy is an inverse function of the length of the antenna baseline, L.ΔAz≈k/L, where k is a constant.

The initialization accuracy for the azimuth angle is approximately 0.15-0.2° at equator for the most accurate of the today's continuous gyro services. A reasonable requirement to the satellite receiver's accuracy is therefore 0.1°. This corresponds to an antenna baseline of approximately 2.5 m.

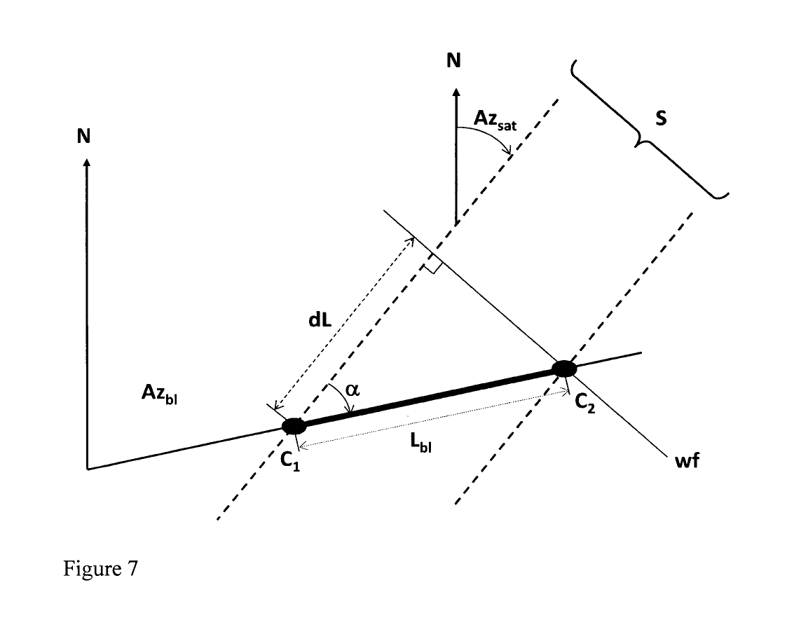

FIG. 7 shows a principle for determining the azimuth angle Az_{bl} of the satellite antenna baseline. By definition, the azimuth angle Az_{bl} lies in the horizontal plane, and the figure shows the horizontal projection of the arrangement.

The satellite beam S, where one wavefront wf is indicated, is received by two antennas C₁ and C₂. These antennas are separated by a baseline of length L_{bl}, which has an arbitrary azimuth orientation Az_{bl} with respect to a reference direction N (North). dL is a horizontal component of a distance difference between the satellite and C₁ and C₂, respectively. This distance is derived from a phase difference of the satellite signal at C₁ and C₂. The angle α between the horizontal projection of the satellite beam and the antenna baseline is thus given by cos(α)=dL/L_{bl}, or α=arccos(dL/L_{bl}). Thus, the unknown azimuth angle of the baseline becomes Az_{bl}=Azₛₐₜ+α=Azₛₐₜ+arccos(dL/L_{bl}).

For the shown arrangement in FIG. 7 with only one satellite and only two antennas, the measurement of phase difference between C₁ and C₂ can only determine dL as a fraction of a wavelength, and an unknown number of whole wavelengths remain unknown. This gives rise to an ambiguity in dL and hence in α. Furthermore, the sign of a can not be uniquely determined. Both these ambiguities are resolved by utilizing simultaneously the signals from several satellites, and by using more antennas. The use of more satellites and more antennas will also improve the accuracy and the reliability of the system. The ambiguity is eliminated by using one additional receiver C3, positioned such that no baselines between any pair of receivers are parallel. The use of this additional receiver also implies additional estimates for the azimuth Azbl, and this can be used to improve the overall accuracy of this parameter.

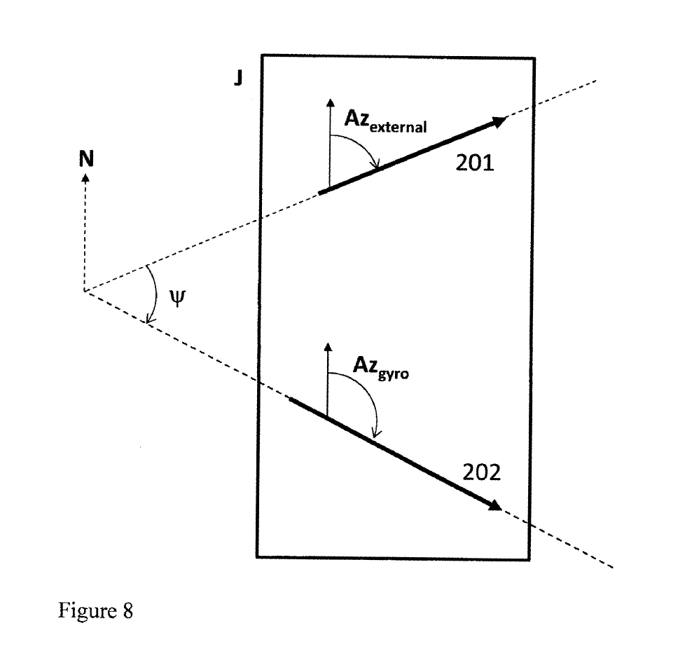

FIG. 8 shows the azimuth orientation of the external navigation system satellite antenna, and of the gyroscopic/inertial instrument 123, as seen from above (projected onto the horizontal plane). 201 is the azimuth reference axis for external navigation system and 202 is the azimuth reference axis for inertial navigation system. The rigid structure shown as 120-124-122 in FIG. 5 is here represented by a single structure J. The azimuth difference angle ψ is solely related to the rigid structure J, and the stiffness of this structure determines the accuracy of ψ during the calibration and initialization processes.

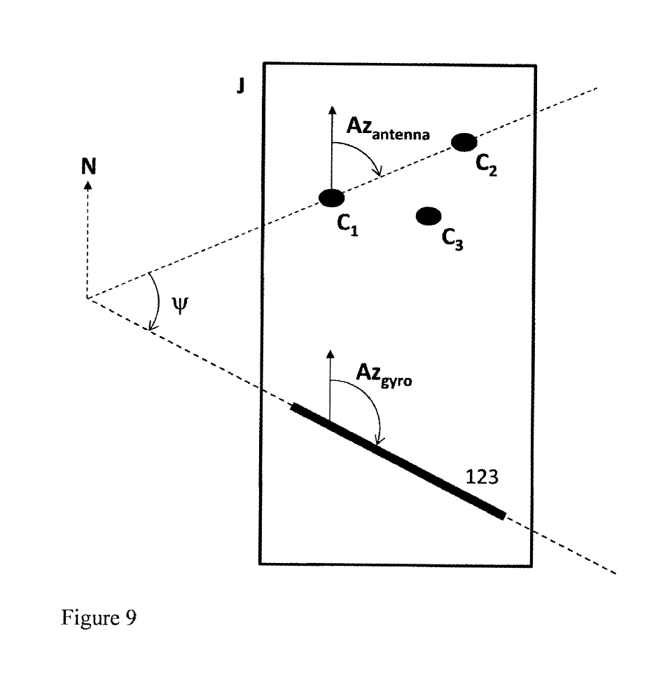

FIG. 9 shows the azimuth orientation of the satellite navigation system satellite antenna, and of the gyroscopic/inertial instrument 123, as seen from above (projected onto the horizontal plane). The rigid structure shown as 121-124-122 in FIG. 6 is here represented by a single structure J. The azimuth difference angle ψ is solely related to the rigid structure J, and the stiffness of this structure determines the accuracy of ψ during the calibration and initialization processes.

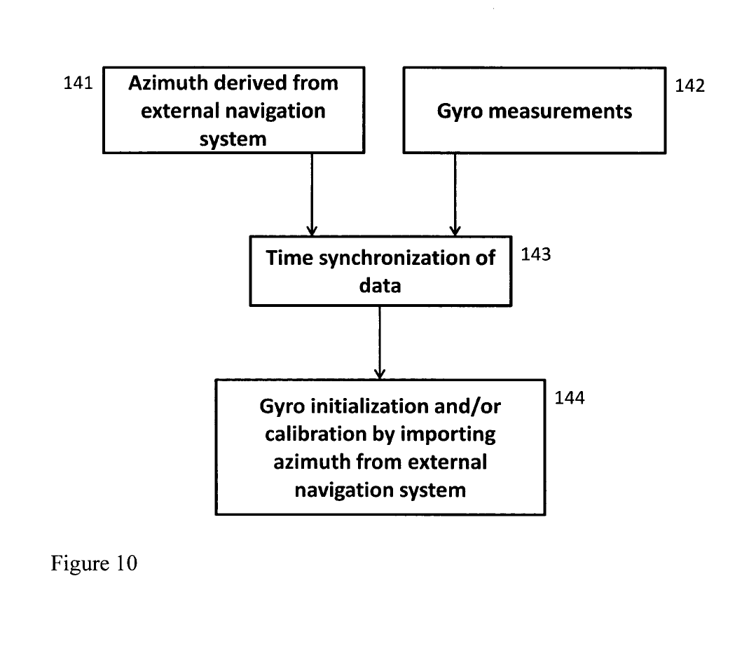

FIG. 10 shows a flow chart for processing of the satellite receiver and gyro instrument readings. After time synchronization, the azimuth derived from the satellite signal replaces the gyro azimuth. This procedure is used for both azimuth initialization of a continuous gyro survey, and for on-site calibration for any gyro service.

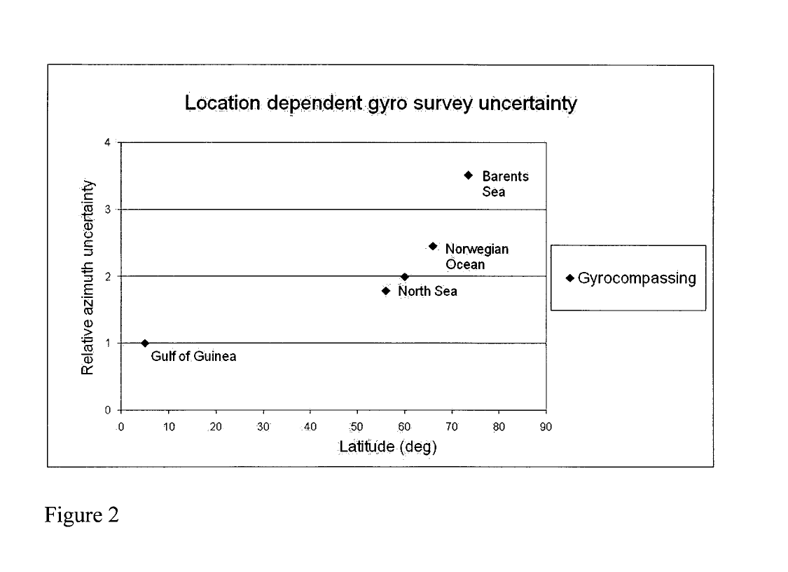

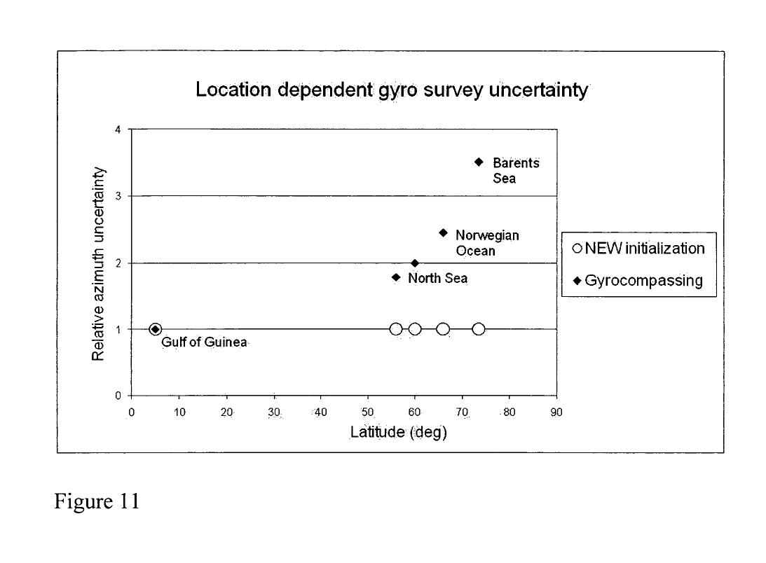

The system is applicable at any geographical location, including far north and far south latitudes. FIG. 11 shows the attainable improvement in azimuth accuracy of a continuous survey, as a function of geographical latitude. The points labeled Gyrocompassing are the same as those shown in FIG. 2. By using the NEW initialization method offered by this invention, the azimuth uncertainty will be independent of latitude, and equal to the value at the equator.

In the description above, the invention exemplify the external navigation system by a satellite system in some of the embodiments, but other external navigation systems can also be applied.

The present invention for azimuth initialization may also be used for calibration of the gyroscopic or inertial instrument.

Applications and Benefits

Continuous Gyroscopic Survey

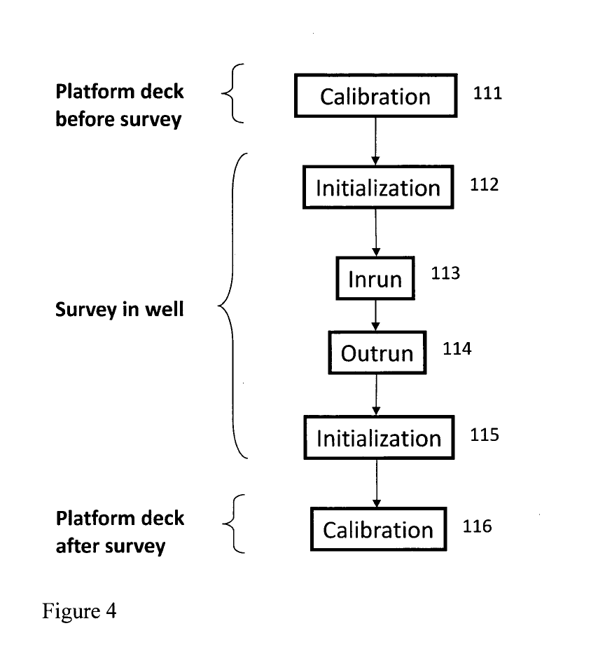

FIG. 4 shows the standard procedure of a continuous gyroscopic survey. The major potential benefits of the external navigation solution are:
Calibration and initialization can be done in a single operation; this will facilitate the calibration/initialization procedure.
The accuracy of azimuth initialization will be independent of latitude (equal to the accuracy at equator); this will improve the total survey accuracy. This holds for any type of gyroscopic and inertial sensor and instrument.
The instrument does not need to be clamped to the wellbore wall or casing for initialization; this will facilitate the initialization procedure.
On-site calibration can be done also on floating installations; this will improve the total survey accuracy.
Reduction of the total survey time; this will reduce the operator's cost.

Notice that with the external navigation solution, initialization will no longer be carried out in the borehole, but on the platform deck.

Stationary Gyroscopic Survey

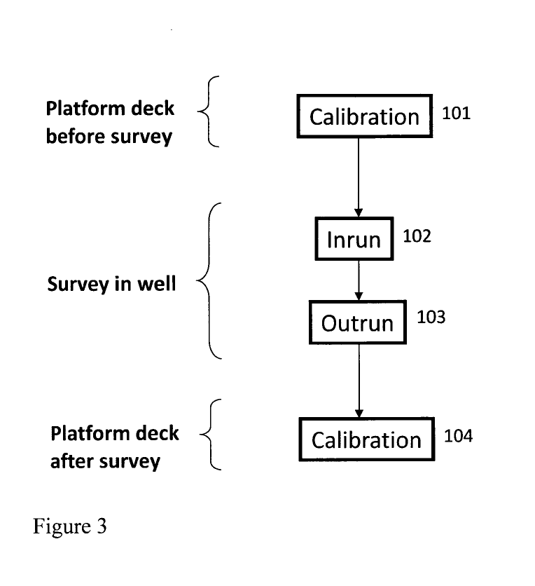

FIG. 3 shows the standard procedure of a stationary gyroscopic survey. The major potential benefit of the external navigation solution is:
On-site calibration can be done also on floating installations; this will improve the total survey accuracy.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1-29. (canceled)

30. System for azimuth initialization of a gyroscopic and/or inertial instrument for wellbore surveying, said system comprising:
a rigid reference structure to which the gyroscopic and/or inertial instrument is rigidly connectable;
an external navigation system for providing an azimuth measurement as a function of time, and wherein the rigid reference structure provides a rigid orientation between the external navigation system and the gyroscopic and/or inertial instrument;
a processor operable to time synchronize the azimuth measurement as a function of time with an orientation as a function of time of the gyroscopic and/or inertial instrument and to replace the azimuth of the gyroscopic and/or inertial instrument with the azimuth measurement as a function of time from the external navigation system.

31. System according to claim 30, wherein the external navigation system is a standalone inertial navigation system.

32. System according to claim 30, wherein said external navigation system is a radio navigation system.

33. System according to claim 30, wherein the external navigation system is a satellite navigation system, e.g. GPS, GLONASS or Galileo.

34. System according to claim 32, further comprising:
at least two antennas for receiving signals from the radio navigation system, wherein the antennas are attached to the rigid reference structure;
a receiver operable to perform synchronous measurements of a carrier phase of at least one signal received by said at least two antennas providing the azimuth as a function of time of the at least two antennas.

35. System according to claim 34, further comprising a further inertial system for providing a dip angle, enabling a fixation of an orientation of a 3D coordinate system in time for the at least two antennas.

36. System according to claim 34, further comprising:
at least three antennas enabling a fixation of an orientation of a 3D coordinate system in time for the at least three antennas.

37. System according to claim 30, further comprising an instrument platform connected to said rigid reference structure to which said gyroscopic or inertial instrument may be rigidly mounted.

38. System according to claim 37, wherein said instrument platform is arranged to provide a horizontal plane.

39. System according to claim 37, wherein said instrument platform is arranged to provide a vertical plane.

40. System according to claim 30, wherein the gyroscopic and/or inertial instrument comprises a gyroscopic sensor and/or an inertial sensor selected from the group including rotating mass gyro, fibre optical gyro, ring laser gyro, vibrating structure gyro/Coriolis vibratory gyro; strap-down and gimballed configurations.

41. System according to claim 30, wherein the wellbore surveying is a stationary or continuous gyro survey.

42. System according to claim 30, wherein the gyroscopic and/or inertial instrument is applicable for both MWD surveys and surveys after drilling.

43. System according to claim 30, wherein the gyroscopic and/or inertial instrument is for use in any mode of motion including fixed, translation, rotation, vibration, and resonance oscillations.

44. System according to claim 30, wherein said system is applicable to gyroscopic and/or inertial instruments used onshore and/or offshore.

45. System according to claim 30, wherein said system is applicable on both floating and fixed installations.

46. Gyroscopic and/or inertial instrument for wellbore surveying arranged for azimuth initialization by a system for azimuth initialization according to claim 30.

47. Method for azimuth initialization of a gyroscopic and/or inertial instrument for wellbore surveying, comprising:
registering orientation and change of orientation as a function of time during azimuth initialization of said gyroscopic and/or inertial instrument by the external navigation system providing an azimuth measurement as a function of time,
registering, during azimuth initialization, orientation and movement as a function of time of said gyroscopic and/or inertial instrument by the inertial registration system of said gyroscopic and/or inertial instrument,
time synchronizing the azimuth measurement as a function of time provided by the external navigation system with the orientation and movement provided by the inertial registration system of the gyroscopic and/or inertial instrument; and
replacing the azimuth as a function of time of the gyroscopic and/or inertial instrument with the azimuth measurement as a function of time from the external navigation system.

48. Method according to claim 47, further comprising:
receiving signals from at least two antennas of the radio navigation system, and
performing synchronous measurements of a carrier phase of at least one signal received by said at least two antennas providing the azimuth as a function of time of the at least two antennas.

49. Method according to claim 48, comprising a further inertial system for providing a dip angle, enabling a fixation of an orientation of a 3D coordinate system in time for the at least two antennas.

50. Method according to claim 47, wherein the gyroscopic and/or inertial instrument utilizes any type of gyroscopic sensors and/or inertial sensors including: rotating mass gyros, fibre optical gyros, ring laser gyros, vibrating structure gyros/Coriolis vibratory gyros; strap-down or gimballed configurations.

51. Method according to claim 47, wherein the external navigation system is a space satellite system, including but not limited to: GPS, GLONASS and Galileo.

52. Method according to claim 47, wherein said method is applicable to both stationary and continuous surveys.

53. Method according to claim 47, wherein said method is applicable to any gyroscopic and/or inertial instrument for both MWD surveys and surveys after drilling.

54. Method according to claim 47, wherein said method is applicable at any geographical location, including far north and far south latitudes.

55. Method according to claim 47, wherein said method is applicable to gyroscopic and/or inertial instruments in any mode of motion: fixed, translation, rotation, vibration, and resonance oscillations.

56. Method according to claim 47, wherein said method is applicable to gyroscopic and/or inertial instruments used onshore and/or offshore.

57. Method according to claim 47, wherein said method is applicable on both floating and fixed installations.

58. Use of a system for azimuth initialization according to claim 30 for calibration of a gyroscopic and/or inertial instrument for wellbore surveying.
